(19) United States
(12) Patent Application Publication
(10) Pub. No.: US 2013/0057557 A1
(43) Pub. Date: Mar. 7, 2013

(54) HIGH AREA STACKED LAYERED METALLIC STRUCTURES AND RELATED METHODS

(71) Applicants: Ravindra Vaman Shenoy, San Jose, CA (US); Philip Jason Stephanou, Mountain View, CA (US); Ana Rangelova Londergan, Santa Clara, CA (US); Evgeni Petrovich Gousev, Saratoga, CA (US)

(72) Inventors: Ravindra Vaman Shenoy, San Jose, CA (US); Philip Jason Stephanou, Mountain View, CA (US); Ana Rangelova Londergan, Santa Clara, CA (US); Evgeni Petrovich Gousev, Saratoga, CA (US)

(73) Assignee: QUALCOMM MEMS TECHNOLOGIES, INC., San Diego, CA (US)

(21) Appl. No.: 13/227,246

(22) Filed: Sep. 7, 2011

(51) Int. Cl. G06T 1/00; G06F 1/16; H01F 27/30; B32B 15/00; B32B 3/00; F28D 15/04; C23F 1/02; H01G 4/30; H01F 5/00

(52) U.S. Cl. 345/501; 361/301.4; 361/679.21; 336/199; 336/200; 428/172; 165/104.26; 216/37; 216/13; 428/615

(57) ABSTRACT

This disclosure provides implementations of high surface area stacked layered metallic structures, devices, apparatus, systems, and related methods. A plurality of stacked layers on a substrate may be manufactured from a plating bath including a first metal and a second metal. A modulated plating current can deposit alternate first metal layers and alloy layers, the alloy layers including the first metal and the second metal. Gaps between the alloy layers can be formed by selectively etching some portions of the first metal layers to define a stacked layered structure. Stacked layered structures may be useful in applications to form capacitors, inductors, catalytic reactors, heat transfer tubes, non-linear springs, filters, batteries, and heavy metal purifiers.

### TECHNICAL FIELD

This disclosure relates generally to a metallic structure and more specifically to a high area stacked layered metallic structure, which can serve as a component or device for a variety of electrical, electro-mechanical, electro-chemical, optical, mechanical, thermal, and fluid-based applications.

### DESCRIPTION OF THE RELATED TECHNOLOGY

Electromechanical systems include devices having electrical and mechanical elements, transducers such as actuators and sensors, optical components such as mirrors, and electronics. Electromechanical systems can be manufactured at a variety of scales including, but not limited to, microscales and nanoscales. For example, microelectromechanical systems (MEMS) devices can include structures having sizes ranging from about one micron to hundreds of microns or more. Nanoelectromechanical systems (NEMS) devices can include structures having sizes smaller than one micron including, for example, sizes smaller than several hundred nanometers. Electromechanical elements may be created using deposition, etching, lithography, and/or other micromachining processes that etch away parts of substrates and/or deposited material layers, or that add layers to form electrical, mechanical, and electromechanical devices.

Various metallic structures can be implemented at the electromechanical systems level. For instance, passive electronic components such as capacitors and inductors can be fabricated as MEMS devices. Such components can have a variety of applications in the electronics industry, particularly consumer microelectronics. Metallic structures also can be used in other industries. Conventional metallic structures are often fabricated in batch processes on silicon wafers and substrates with multiple processing stages including thin film deposition, photolithography, plating and etching. Such silicon-based fabrication techniques can be expensive, time-consuming, and are not easily transported to substrates formed of other materials.

### SUMMARY

The structures, devices, apparatus, systems, and methods of the disclosure each have several innovative aspects, no single one of which is solely responsible for the desirable attributes disclosed herein.

Disclosed are implementations of stacked layered metallic structures, devices, apparatus, systems, and related fabrication methods.

According to one innovative aspect of the subject matter described in this disclosure, a method of forming a plurality of stacked layers on a substrate from a plating bath includes: plating to deposit at least one layer of a first material and at least one layer of a second material, and selectively etching portions of the first material.

In some implementations, the first material is a first metal, and the second material is an alloy including the first metal and a second metal. Plating includes modulating a plating current to deposit alternate layers of the first metal and the alloy. Selectively etching includes forming gaps between regions of the alloy layers. The alternate layers of etched first metal layers and alloy layers define a stacked layered structure.

In some implementations, a dielectric material is deposited on a surface of the stacked layered structure. A conductive layer is deposited on the dielectric material to define a capacitor including a first electrode and a second electrode. The first electrode is the stacked layered structure, and the second electrode is the conductive layer. The dielectric material can be deposited using atomic layer deposition (ALD). The conductive layer can be deposited using electroless plating.

In some implementations, an electrode layer of conductive material is formed on the alloy layers to partially fill the gaps, and a liquid electrolyte is provided in the partially filled gaps. A gas phase reactant can be provided to the liquid electrolyte, where the gas phase reactant is capable of reacting with the electrode layer material. In an alternative implementation, a liquid phase reactant can be provided to the liquid electrolyte, where the liquid phase reactant is capable of reacting with the electrode layer material.

According to another innovative aspect of the subject matter described in this disclosure, a device includes at least one layer of a first material, and at least one layer of a second material having one or more portions extending beyond the first material layer(s). In some implementations, the one or more extending portions of the alloy layers define one or more gaps between regions of the alloy layers. Alternate layers of first metal layers and alloy layers define a stacked layered structure.

In various implementations, the stacked layered structure can form at least a part of a device such as a capacitor, an inductor, a sensor, a catalyst matrix, a heat pipe, a fluidic filter, an electrochemical cell, an electromechanical cell, and an electrode.

According to another innovative aspect of the subject matter described in this disclosure, apparatus includes a plurality of separated, stacked alloy layers formed of an alloy of a first metal and a second metal. The separated metal layers define gaps therebetween. The apparatus further includes separating means for separating the stacked metal layers from each other to form gaps between regions of the alloy layers. The alternate layers of the separating means and the alloy layers define a stacked layered structure.

In some implementations, the apparatus includes conductive means for storing charge. The conductive means is disposed on the dielectric material. The stacked layered structure defines a first electrode of a capacitor, and the conductive means defines a second electrode of the capacitor. In some other implementations, the apparatus includes one or more coils disposed about the stacked layered structure.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a flow diagram illustrating a method for forming a stacked layered structure.

FIG. 2A shows an example of a side view of a stacked layered structure.

FIG. 2B shows an example of a side view of an etched stacked layered structure.

FIG. 3 shows an example of a flow diagram illustrating a method for forming a capacitor from a stacked layered structure.

FIG. 4A shows an example of a side view of a stacked layered structure coated with a dielectric material.

FIG. 4B shows an example of a side view of a capacitor formed from a stacked layered structure.

FIG. 5 shows an example of a flow diagram illustrating a method for forming an inductor from a stacked layered structure.

FIG. 6A shows an example of a side view of a stacked layered structure coated with a dielectric material.

FIG. 6B shows an example of a perspective view of an inductor having a stacked layered structure serving as a magnetic core.

FIG. 7 shows an example of a side view of a sensor formed from a stacked layered structure.

FIG. 8 shows an example of a side view of a nano-catalyst matrix formed from a stacked layered structure.

FIG. 9 shows an example of a side view of a heat pipe formed from stacked layered structures.

FIG. 10 shows an example of a side view of a stacked layered structure.

FIG. 11 shows an example of a side view of a micro-fluidic filter formed from a stacked layered structure.

FIG. 12 shows an example of a flow diagram illustrating a method for forming an electrochemical cell from a stacked layered structure serving as a large area electrode or a large area current collector.

FIG. 13 shows an example of a side view of an electromechanical cell formed from a stacked layered structure serving as a large area electrode or a large area current collector.

FIG. 14 shows an example of a side view of a large area electrode formed from a stacked layered structure for pollution abatement by plating of metallic ions from dilute solution streams.

FIG. 15 shows an example of a flow diagram illustrating a method of forming an inductor by depositing coil portions around a stacked layered structure.

FIGS. 16A-16E show an example of a top view of an inductor at respective stages of fabrication.

FIGS. 17A-17E show an example of a cross-sectional view along lines 17-17 of FIG. 16A of the inductor of FIGS. 16A-16E at the respective stages of fabrication.

FIG. 18A shows an example of an isometric view depicting two adjacent pixels in a series of pixels of an interferometric modulator (IMOD) display device.

FIG. 18B shows an example of a system block diagram illustrating an electronic device incorporating a 3×3 interferometric modulator display.

FIGS. 19A and 19B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways.

The disclosed implementations include examples of structures and configurations of high area stacked layered metallic structures. Related apparatus, systems, and fabrication methods and techniques are also disclosed.

The disclosed implementations include apparatus, systems, and related methods of a high area stacked structure formed of metal layers. This stacked layered structure can serve as a building block for a capacitor, inductor, sensor, catalyst matrix, heat pipe, supportive structure, optical filter, electrochemical cell such as a battery or a fuel cell, fluid filter, and other devices and systems. The stacked layers can be formed on a substrate, such as glass, from a plating bath including a first metal and a second metal. The substrate can be rigid or flexible, depending on the desired implementation. A plating current is modulated to deposit alternate layers of the first metal, and an alloy of the first metal and the second metal, from the plating bath. Stacked layers of metal can be deposited in this manner in a direction perpendicular to the plane of the substrate. Portions of alternate layers, such as the first metal layers, can be selectively etched to form gaps between regions of the interposed alloy layers. In some implementations, the stacked layered structure can be fabricated with minimal processing operations, for instance, using a single lithography operation, a single plating operation, and a single etching operation.

In some implementations, the stacked layered structure can be fabricated by sequential deposition of alternate layers of a first metal and an alloy of the first metal and a second metal from a single plating bath where the choice of the first and second metal can be based on electrochemistry, that is, for the current modulation to yield a pure or almost pure metal layer at one current density and an alloy of the first and second metals at another current density. A low concentration of the first metal can be added to a plating bath of the second metal. In some examples, the stacked layered structure can be fabricated by alternate and sequential deposition of a layer of copper (Cu), followed by a layer of an alloy of Cu and a second metal such as Nickel (Ni), and/or Iron (Fe), and/or Cobalt (Co). For instance, in the case of an inductor, the alloy layer can be (Ni₄₅Fe₅₅)₉₈Cu₂.

In some implementations, when a low concentration of the first metal (such as Cu) is added to a single plating bath of the second metal such as a Nickel-Iron mixture (NiFe), the alternate deposition of layers can be accomplished by modulating the plating current. At low current density, in this example, a pure or almost pure layer of Cu is deposited. At higher current densities, in this example, closer to nominal NiFe plating current densities, a NiFeCu alloy is plated. The layers can have the same or different thicknesses, depending on the desired application. A stack of alternate layers can be fabricated through modulating the plating current density from a single plating bath.

After forming the stacked alternate layers of a first metal, in this example Cu, and an alloy of the first metal and a second metal, the stacked layered structure can be selectively etched using an etchant, such as a combination of hydrogen peroxide and acetic acid, to remove peripheral regions of the first metal. The etching time is controlled to leave a core region of the first metal, in this example Cu, intact. Alternatively, in this example, NiCu can be etched selectively in the presence of Cu, leaving layers of Cu and a core region of NiCu intact.

In some implementations, the stacked layered structure can serve as one electrode of a capacitor. Here, a dielectric material can be deposited about a surface of the stacked layered structure, for instance, using atomic layer deposition (ALD). A conductive layer can be deposited over the dielectric material to define a second electrode of the capacitor. In some implementations, the stacked layered structure can serve as a high surface area on which a Metal-Insulator-Metal (MIM) capacitor can be fabricated through sequential deposition of metal, insulator and metal using atomic layer deposition (ALD), by way of example. In some other implementations, the stacked layered structure can serve as a magnetic metal core of an inductor. One or more coils can be disposed about a surface of the stacked layered structure to realize the inductor.

In some examples of apparatus and systems incorporating the stacked layered structure, a sensor layer can be formed on the stacked layered structure. In some other examples, the current modulation can be adjusted during formation of the stacked layers such that the different layers of the first metal have different thicknesses from one another and thus define different gap surface areas when portions of the first metal layers are selectively etched. The alloy layers also can have different thicknesses, also controlled by modulating the plating current, depending on the desired applications. In some other examples, an electrochemical cell can be formed using the stacked layered structure as a large area electrode or a large area current collector on which a large area electrode is formed. An electrode layer of conductive material can be deposited on the surfaces of the alloy layers, while sidewall regions of the first metal core layers in the gaps remain exposed. A liquid electrolyte can be introduced into the gaps. A gas phase reactant can be introduced to the liquid electrolyte. The gas phase reactant is capable of reacting with the electrode layer material. A liquid phase reactant, also capable of reacting with the electrode layer material, can then be introduced to the liquid electrolyte.

Particular implementations of the subject matter described in this disclosure can be implemented to realize one or more of the following potential advantages. The stacked structure of alternate layers of metal and alloy can be used to fabricate devices with very large surface areas while keeping the device size relatively compact or to fabricate devices that can benefit from multiple layers separated by air gaps. Such stacked structures can find use as a component of various devices and systems, including MEMS capacitors and inductors, surface-mounted and microfluidic sensors, a nano-catalyst matrix, a micro-heat pipe, pyramidal structures, microfluidic filters, optical filters, battery/fuel cell electrodes, and metal pollution abatement systems. The structures can be fabricated in a batch process with a minimal number of lithography, plating and etching process operations to keep the fabrication cost low.

Also, the structures can be fabricated on a substrate such as glass and readily integrated with other various components, circuits, and devices on the substrate to reduce costs. For example, a capacitor incorporating the stacked layered structure can be fabricated on a glass substrate and interconnected with other passive and active circuit components on the substrate. Also, from a general electrical perspective, forming passive components/circuits on glass can be more desirable than forming the components/circuits on silicon. This is because glass is an insulating material, while silicon is a semi-conducting material. Also, using substrates such as glass, larger wafers (such as 5× or 20× larger in area and a corresponding number of parts) can be used as opposed to silicon. Finally, glass panels may be cheaper than silicon wafers.

In the case of a capacitor incorporating the stacked layered structure, unique electro-deposition properties of a first metal such as Cu with a second metal such as Ni or some combination of Ni, Co, and/or Fe, facilitate plating and selective wet etching of the stacked layered structure in a reproducible manner. The use of ALD to deposit conformal thin dielectric and metal layers in very high aspect ratio gaps/openings enables fabrication of large capacitance capacitors. For example, capacitors with high per-unit capacitance on the order of 0.1 microfarad (uF)/mm² or larger can be formed. A large capacitance value can be obtained by virtue of the large surface area of the stacked layered structure serving as one of the capacitor electrodes. A high dielectric constant and a thin gap between the electrodes can be achieved with thin continuous conformal dielectric deposition, and also can serve to increase the capacitance value.

In the case of an inductor, incorporating the stacked layered structure as a magnetic core of a spiral or solenoidal inductor with high magnetic moment and high permeability can increase inductance values. The thicknesses of the layers and number of layers can be set to effectively increase the magnetic core resistivity and reduce eddy current losses to improve high frequency performance, for instance, in circuits operating at frequencies over 20 MHz. High magnetic moment plated alloys such as cobalt-iron (CoFe) can be used as the second metal.

The disclosed stacked layered structures can be fabricated on low-cost, high-performance, large-area, insulating substrates or panels. For example, the substrate on which the disclosed structures are formed can be made of display grade glass (alkaline earth boro-aluminosilicate) or soda lime glass. Other suitable substrate materials include silicate glasses, such as alkaline earth aluminosilicate, borosilicate, modified borosilicate, and others. Alternatively, ceramic materials such as aluminum oxide (AlOx), yttrium oxide (Y₂O₃), boron nitride (BN), silicon carbide (SiC), aluminum nitride (AlNx), and gallium nitride (GaNx) can be used as the substrate material. In other examples, the substrate is formed of high-resistivity silicon. Silicon On Insulator (SOI) substrates, gallium arsenide (GaAs) substrates, indium phosphide (InP) substrates, and plastic (polyethylene naphthalate or polyethylene terephthalate) substrates, also can be used. The substrate can be in conventional Integrated Circuit (IC) wafer form, e.g., 4-inch, 6-inch, 8-inch, 12-inch, or in large-area panel form. For example, flat panel display substrates that have dimensions such as 370 mm×470 mm, 920 mm×730 mm, and 2850 mm×3050 mm, can be used. These and other substrates may be used, depending upon the application and design parameters.

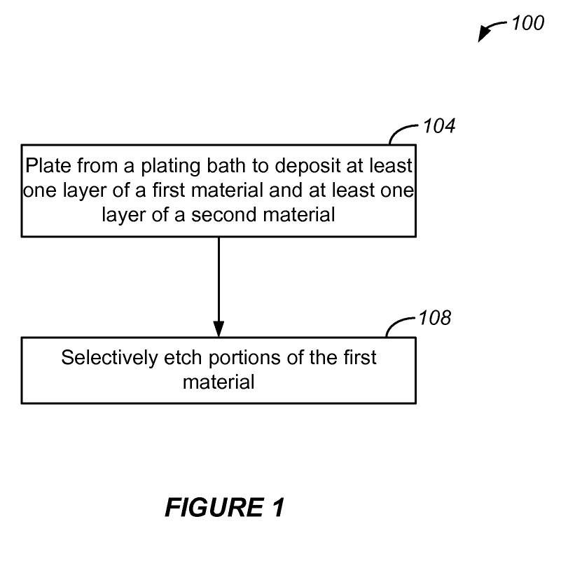

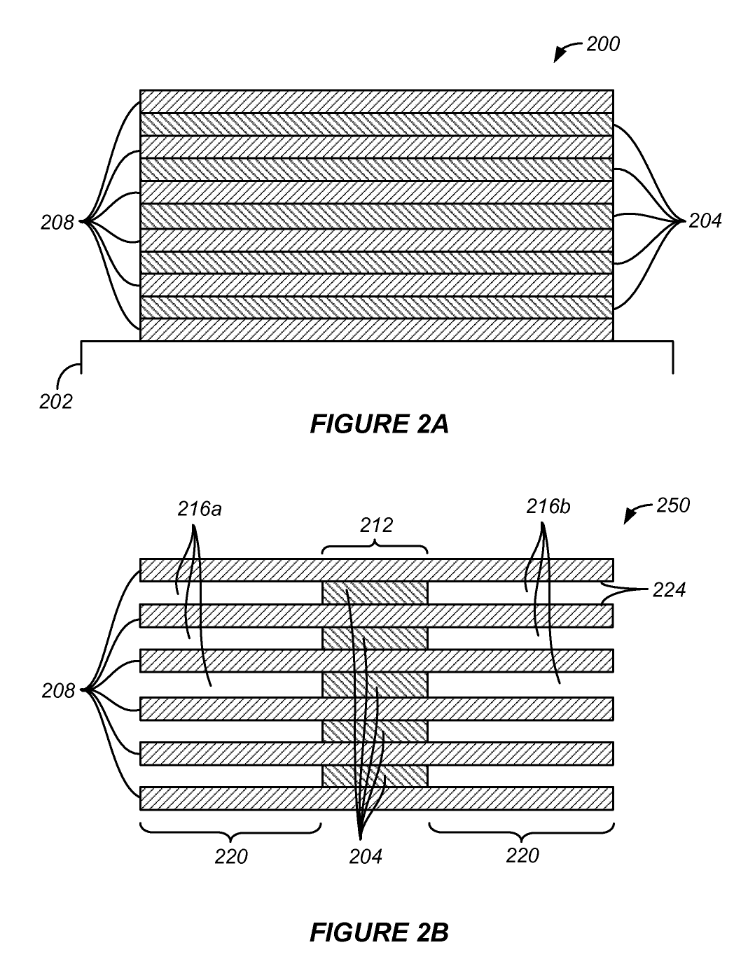

FIG. 1 shows an example of a flow diagram illustrating a method for forming a stacked layered structure. FIG. 1 is described with reference to FIGS. 2A and 2B, which show, respectively, an example of a side view of a stacked layered structure and an example of a side view of an etched stacked layered structure.

In FIG. 1, method 100 begins in block 104, with plating from a plating bath to deposit at least one layer of a first material and at least one layer of a second material. In some implementations, the first material is a first metal, and the second material is an alloy including the first metal and a second metal, as explained in the examples below. The layers of metal are formed in a stack 200 on a substrate 202, as shown in FIG. 2A. In some implementations, the stacked layers 200 are formed on a surface of the substrate 202 from a plating bath including a relatively low concentration of the first metal with the second metal. For example, the first metal can be copper (Cu). The second metal can be nickel (Ni), cobalt (Co), iron (Fe), or other metals. In another example, the second metal can be a combination of metals such as Ni and Co, Co and Fe, or Ni combined with Co and Fe. A plating current can be modulated to deposit alternate layers of the first metal 204 and an alloy 208 including the first metal and the second metal. For example, the stacked layers of first metal 204 and alloy 208 can be formed in a single plating operation by modulating current as a function of time to plate a layer of pure or nearly pure first metal 204 at a lower current density, then plate a layer of alloy 208 at a relatively higher current density. In this example, at the higher current density, the first metal in the plating bath is consumed locally so an alloy of the first metal and the second metal is plated. The current density can be varied over a designated time to repeat these two operations and deposit a desired number of alternate layers. As illustrated, the plating operation began with a relatively higher current density and hence the layer of alloy 208 is plated first on the glass, followed by a lower current density to plate the first metal 208, and so forth. By way of example, 100 nm thick Cu layers can be interspersed with 1000 nm thick NiFeCu layers.

In FIG. 1, following the formation of the stacked layers 200 in block 104, method 100 proceeds to block 108 in which portions of the first metal layers 204 are selectively etched to form gaps 216a and 216b between regions 220 of the alloy layers 208 as shown in FIG. 2B. Portions of the alloy layers 208 in regions 220 extend beyond areas occupied by the remaining portions of the first metal layers 204 to define the gaps 216a and 216b, in this example. The stacked layered structure 250 shown in FIG. 2B, defined by the partial etching of portions of the first metal layers 204, results from block 108. The alloy layers 208 now have exposed surfaces 224 in the gaps 216a and 216b and are supported by the remaining portions of the first metal layers 204. These exposed surfaces 224 significantly add to the overall surface area of the stacked layered structure 250. In the example of FIG. 2B, the remaining portions of the first metal layers 204 are located in a core region 212 of the structure 250. In this example, the gaps 216a and 216b are similar in surface area and are situated on respective sides of the core region 212. In other examples, the remaining portions of the first metal layers 204 can be shifted to one side with respect to the example of FIG. 2B, such that the gaps 216a and 216b have different exposed surface areas with respect to one another, or one set of gaps 216a or 216b are omitted. The remaining portions of first metal layers 204, as well as portions of the interposed alloy layers 208 in contact with the remaining portions of the first metal layers, can be collectively viewed as a core or post of the stacked layered structure.

In FIG. 1, the selective etching in block 108 can be performed in a single etching operation, in some implementations. Etchants can be selected that will etch the first metal but not etch the alloy of the first metal and the second metal. For instance, hydrogen peroxide acidic acid or ammonia nickel copper etch can be used to selectively etch pure copper layers. The amount of first metal material removed by the etching is generally determined by etch time. Various dimensions can be created based on the length of time the metal layers are exposed to the etchant.

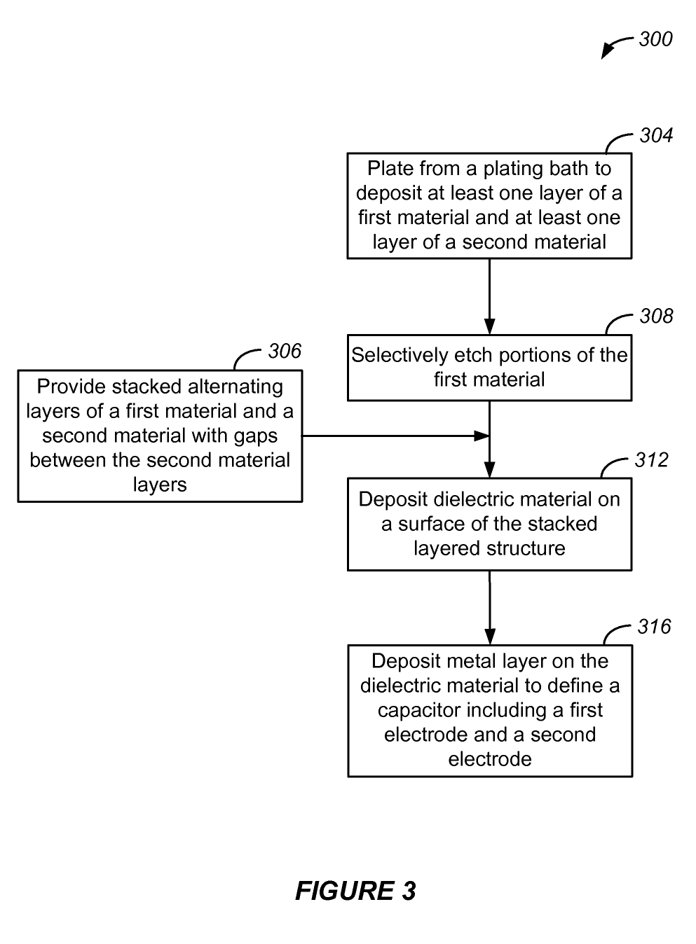

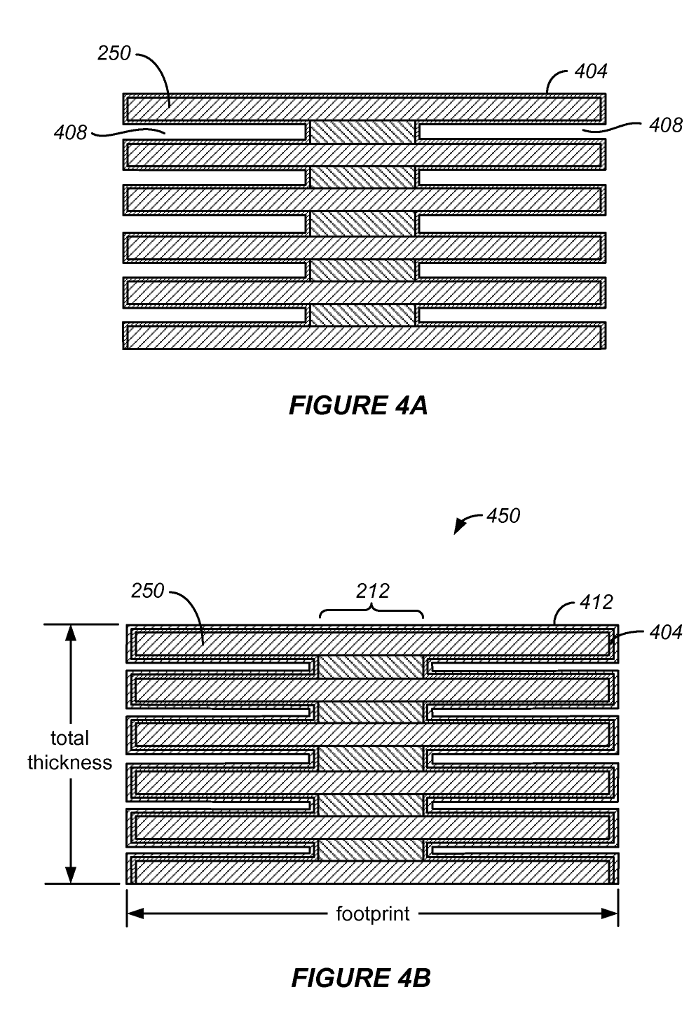

FIG. 3 shows an example of a flow diagram illustrating a method for forming a capacitor from a stacked layered structure. FIG. 3 is described with reference to FIGS. 4A and 4B, which show, respectively, an example of a side view of a stacked layered structure coated with a dielectric material and an example of a side view of a capacitor formed from a stacked layered structure.

In FIG. 3, method 300 begins with block 304 and 308, which are similar to blocks 104 and 108 of FIG. 1, as described above. Block 304 and 308 result in the formation of a stacked layered structure 250 similar to that of FIG. 2B. Alternatively, as shown in block 306, the stacked layered structure 250 including stacked, alternating layers of a first material and a second material, with gaps between the second material layers can be provided for subsequent processing in blocks 312 and 316. In some implementations, the first material includes a first metal and the second material includes an alloy including the first metal and a second metal. In such implementations, the stacked layered structure 250 can be manufactured prior to performing the method 300. In block 312, a dielectric material 404 such as alumina can be deposited about a surface of the stacked layered structure 250, as shown in FIG. 4A. Various dielectric materials can be used, such as aluminum oxide (Al₂O₃), zirconium oxide (ZrO₂) and tantalum dioxide (Ta₂O₅). The dielectric material 404 can be deposited using atomic layer deposition (ALD). Such a surface-based deposition technique can facilitate coverage of all of the exposed surfaces of the stacked layered structure 250 with a uniform thickness of the deposited dielectric material 404. The thickness may be very small, for instance, on the order of 100 Angstroms. As shown in FIG. 4A, the layer of dielectric material 404 is relatively thin, as layer 404 coats the outer surface of the stacked layered structure 250 while leaving substantial regions 408 of the gaps 216a and 216b. That is, the dielectric material 404 coats the exposed top and bottom surfaces 224 of the alloy layers 208 and side walls of the remaining portions of the first metal layers 204, while the remaining regions 408 of the gaps 216a and 216b are unfilled. These remaining regions 408 can be high aspect ratio lateral cavities, for instance, when ALD or other surface chemistry based technique is used to deposit the dielectric material 404.

In FIG. 3, method 300 continues to block 316 following the deposition of the dielectric material 404 in block 312, with the deposition of a conductive layer 412, as shown in FIG. 4B. This conductive layer 412 can include one or more metals such as ruthenium (Ru), platinum (Pt), rhodium (Rh), and/or iridium (Ir). In some implementations, the conductive layer 412 also can be deposited using ALD in the regions 408 remaining after deposition of the dielectric material 404. In such implementations, the metal can be any metal that may be deposited using ALD or other surface chemistry based technique. In some other implementations, the conductive layer 412 can be deposited using techniques such as electroless plating, also referred to as chemical or auto-catalytic plating. As shown in FIG. 4B, the thin conductive layer 412 coats the surface of the dielectric material 404 disposed about the structure 250, while leaving portions of regions 408 unfilled, in this example. In other examples, the regions 408 can be filled with the conductive layer 412.

In FIG. 4B, the resulting structure 450 can define a capacitor including a first electrode in the form of the original stacked layered structure 250. A second electrode is in the form of the outer conductive layer 412 disposed about the dielectric material 404. The number of layers and total stack thickness are variables that can be increased to increase the surface area of the structure. Increasing the total thickness and/or increasing the number of layers for a given layout footprint results in an increase in the effective transduction surface area of the stacked layered structure. For instance, a 20 micrometer-thick structure would have 4× more layers than a 5 micrometer-thick stack, when layer thickness is constant, and thus more surface area. Also, the thicknesses of one or more individual layers can be engineered to control the surface area of the structure and finely tune the capacitance. Thus, capacitors can be constructed with a wide variety of different capacitance values, depending on the desired implementation. In one example, fifty layers or more of Cu (first metal) interposed with alloy layers of Cu with NiCu (second metal) can be deposited. High aspect ratio metal plating processes can be used to plate structures having total thicknesses in the ranges of 100 to 1000 micrometers or more, enabling further increases in capacitor area per unit footprint. That is, the area increases as the number of layers in the stack grows. For instance, for a 500 micrometer×500 micrometer footprint, with a 100 micrometer-wide core region 212, the following capacitance increases can be realized (over the capacitance of a single layer):

5 layers=9× capacitor area increase over footprint

10 layers=19× capacitor area increase over footprint

20 layers=38× capacitor area increase over footprint

40 layers=76× capacitor area increase over footprint

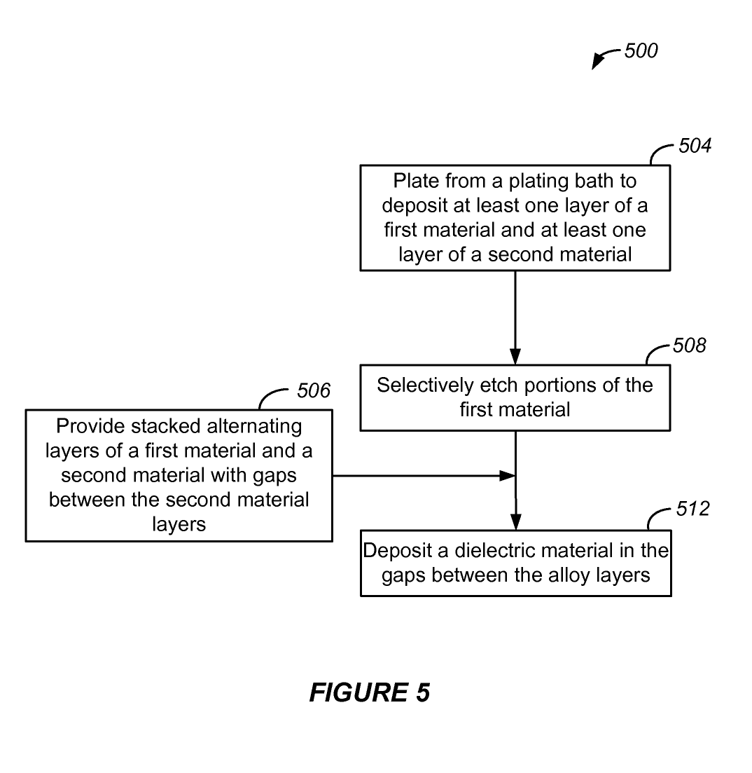

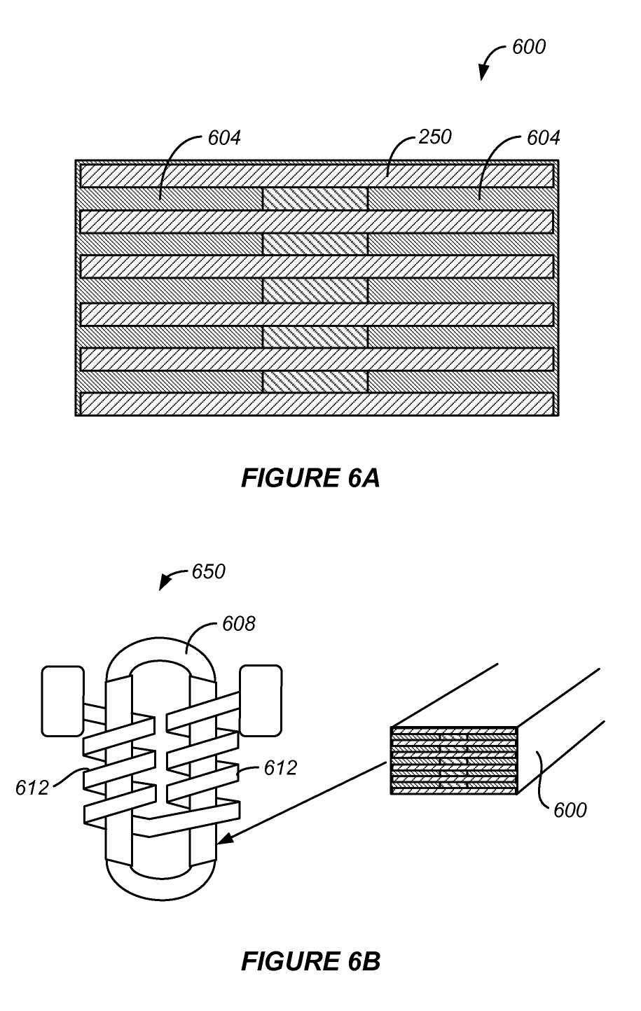

FIG. 5 shows an example of a flow diagram illustrating a method for forming an inductor from a stacked layered structure. FIG. 5 is described with reference to FIGS. 6A and 6B, which show, respectively, an example of a side view of a stacked layered structure coated with a dielectric material and an example of a perspective view of an inductor having a stacked layered structure serving as a magnetic core.

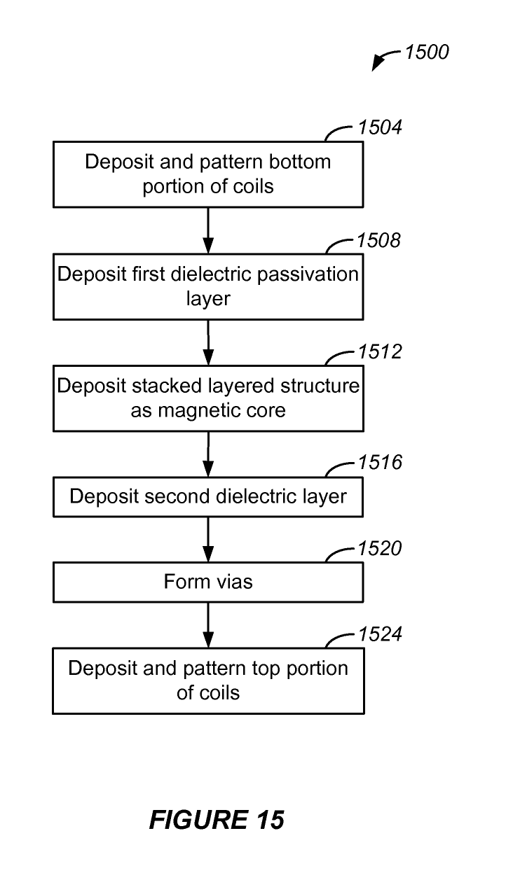

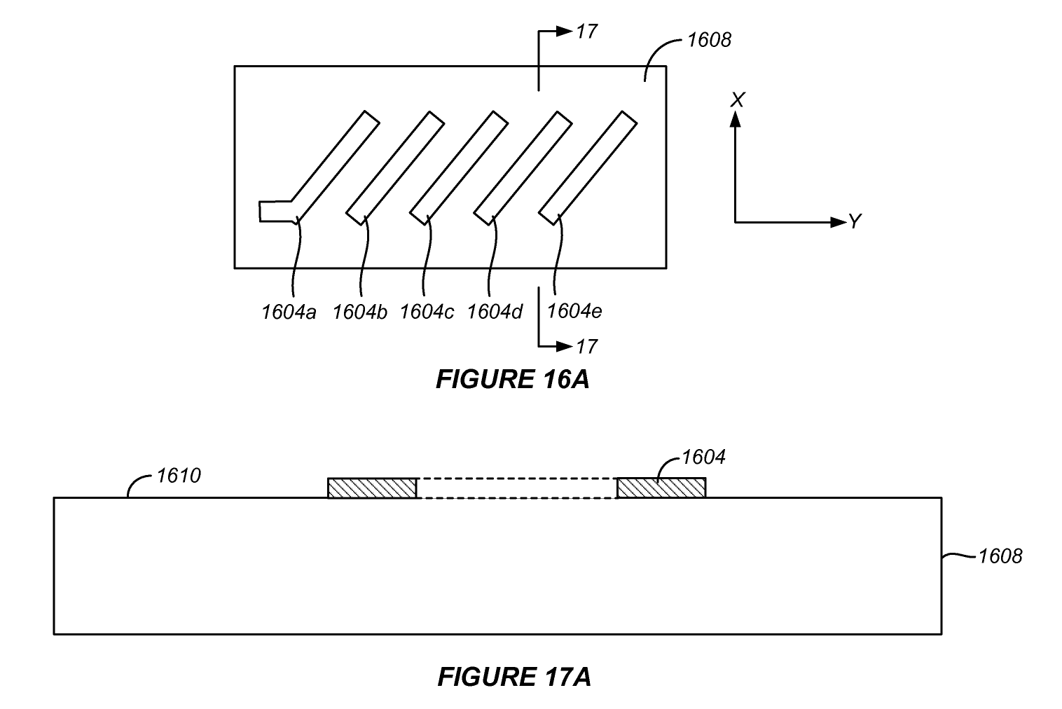

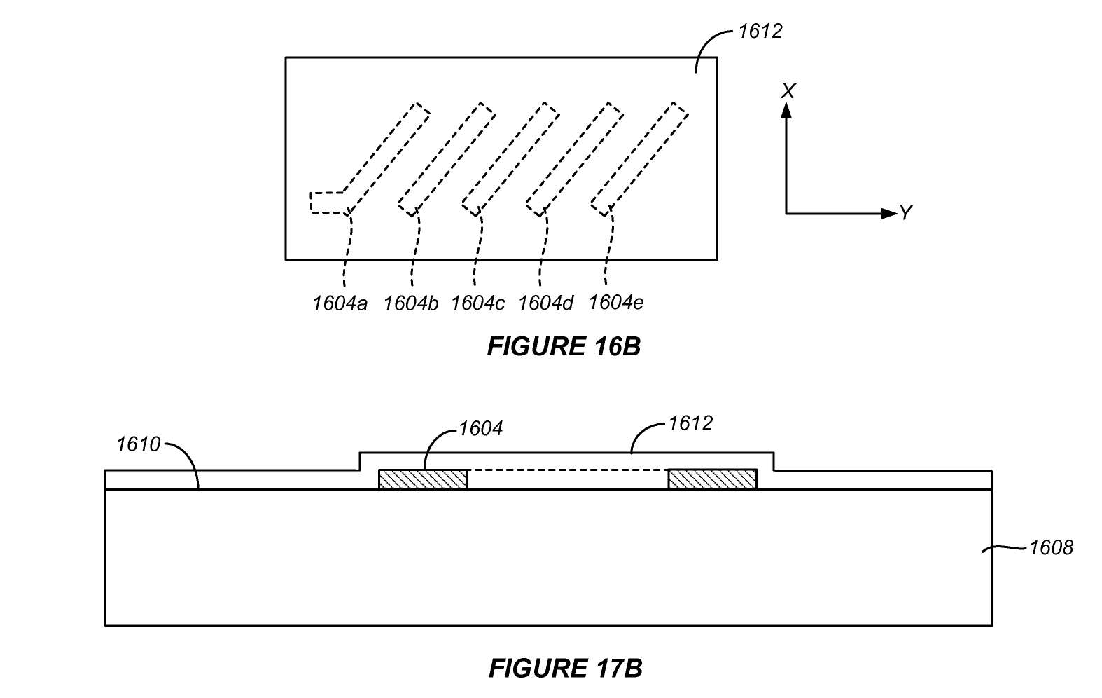

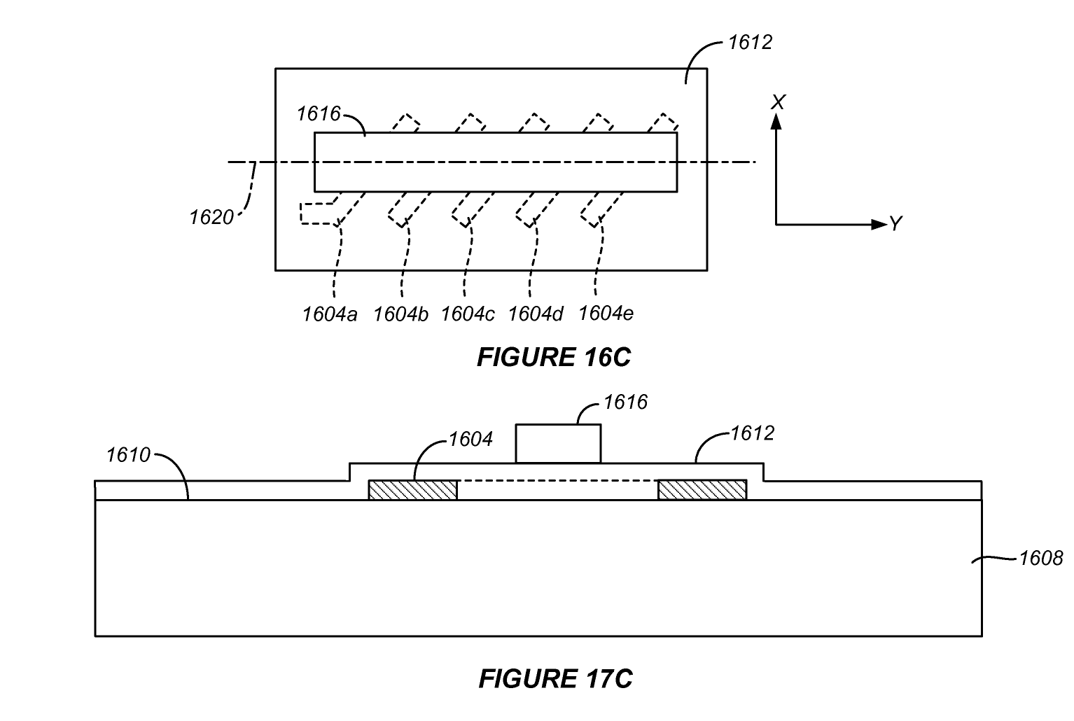

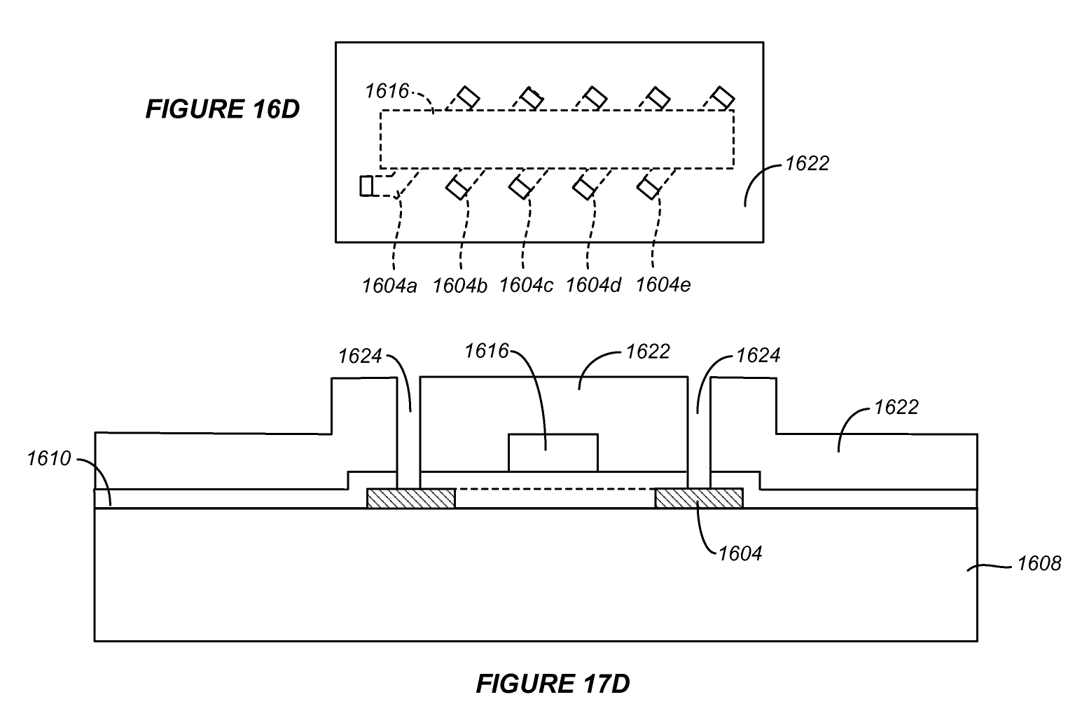

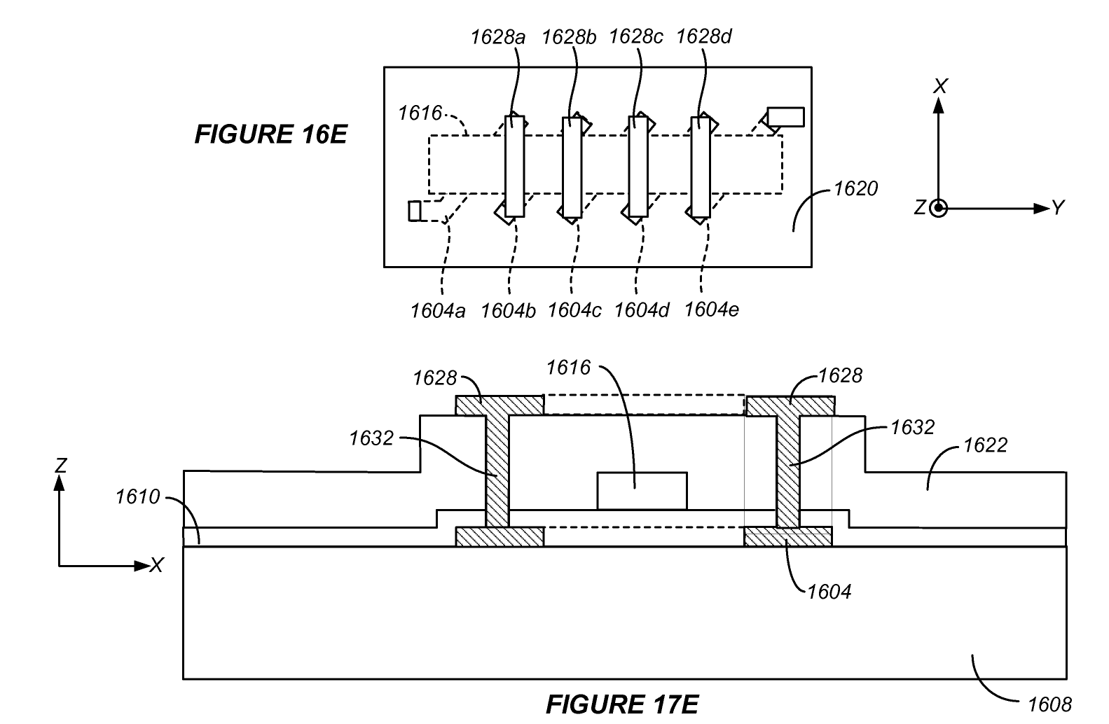

In FIG. 5, method 500 begins in blocks 504 and 508, which are similar to blocks 104 and 108 of FIG. 1 described above. Blocks 504 and 508 result in the formation of a stacked layered structure 250 similar to that of FIG. 2B. Alternatively, as shown in block 506, the stacked layered structure 250 including stacked, alternating layers of a first material and a second material, with gaps between the second material layers may be provided for subsequent processing in block 512. In some implementations, the first material includes a first metal and the second material includes an alloy including the first metal and a second metal. In such implementations, the stacked layered structure 250 can be manufactured prior to performing the method 500. In block 512, a dielectric material 604 as described above with reference to FIG. 3 is deposited on the surface of the structure 250, as shown in FIG. 6A. In this example, the dielectric material 604 is deposited in a manner such that the material 604 fills the gaps 216a and 216b (FIG. 2B) on both sides of the core region 212 (FIG. 2B) of the structure 250. The resulting structure 600 can serve as a laminated magnetic core 608, as shown in FIG. 6B. Solenoidal coils 612 formed of an appropriate metal such as Cu can be fabricated by planar induction processes and wrapped around the magnetic core 608 as shown in FIG. 6B to realize the inductor 650. An example of a method for forming coils around a stacked layered structure is described in greater detail below with reference to FIG. 15, FIGS. 16A-16E, and FIGS. 17A-17E. As current passes through the coils 612, a magnetic field is generated. As the frequency of the current signal increases, eddy currents inside of the core 608 are minimized or significantly reduced. This is due in large part to the gaps 216a and 216b having been filled with dielectric material 604.

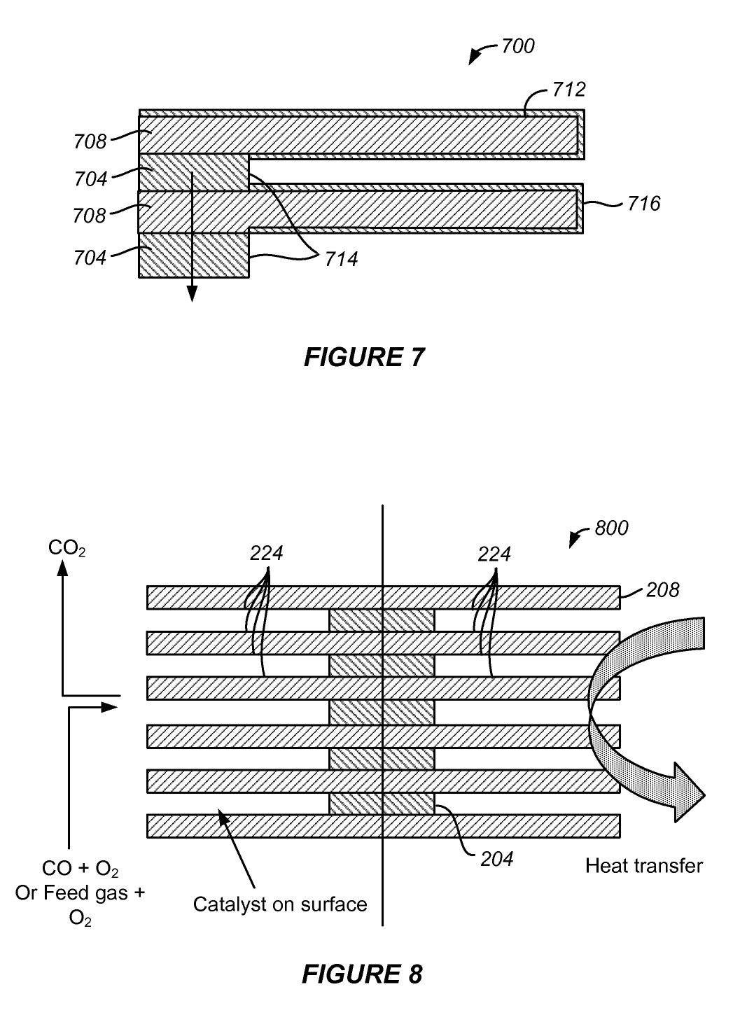

FIG. 7 shows an example of a side view of a sensor formed from a stacked layered structure. For example, the stacked layered structure of FIG. 2B can be formed in accordance with method 100 of FIG. 1, in some implementations. The stacked layered structure includes alternate etched first metal layers 704 and alloy layers 708. For example, the first metal layers 704 can be formed of copper, while the alloy layers are formed of copper and nickel. A sensor layer 712 is formed on exposed surfaces of the alloy layer 708. As seen in FIG. 7, exposed regions 714 on sidewalls of the first metal layers 704 are not coated with sensor layer 712, in some implementations.

In FIG. 7, the sensor layer 712 can be formed of Platinum (Pt) either by plating or ALD on the alloy surfaces, by way of example. The Pt can then be coated with an ion-selective polymer 716 to form the sensor. The resulting structure 700 can be used as a surface mounted sensor. One or more of such surface mounted sensors can be included in electronic monitoring devices and systems to provide signal amplification, which can be increased with the use of additional such sensors. Such structures 700 also can be used as gas sensors and other various specific sensor applications. Because the nickel alloy layers 708 cover a significantly large area, the various sensor applications of structure 700 can benefit from a large surface area selective electrode defined by layers 704 and 708.

Another application of the structure 700 in FIG. 7 is a microfluidic sensor. The large surface area electrode defined by layers 704 and 708 can provide fluid flow and mass transport characteristics for microfluidic sensor applications. The above-described nickel framework of alloy layers 708 is provided over a large footprint area, and liquids passing between the nickel alloy layers 708 can cause amplification of various signals.

FIG. 8 shows an example of a side view of a nano-catalyst matrix formed from a stacked layered structure. In FIG. 8, the same structure described above with reference to FIGS. 1, 2A, and 2B, can be used. In this application, the exposed surfaces 224 of the alloy layers 208 can provide a large surface area for attaching a catalyst on the surface of the structure 800. For instance, a catalyst can be attached by electrolytic or electroless plating using Pt and/or other noble metals. Also, catalysts can be attached by electrophoretic application. Various catalytic reactions can be provided such as carbon monoxide (CO) to carbon dioxide (CO₂) conversion, nitrogen oxide (NOx) reduction, and natural gas combustion. The large surface area of the stacked layered structure 800 on which the catalyst is provided can facilitate the transfer of heat generated during the catalytic reaction. The metal frame defined by layers 204 and 208 of the structure 800 can be heated by an endothermic reaction or cooled by an exothermic reaction for efficient heat transfer, that is, heat in or heat out of the structure 800.

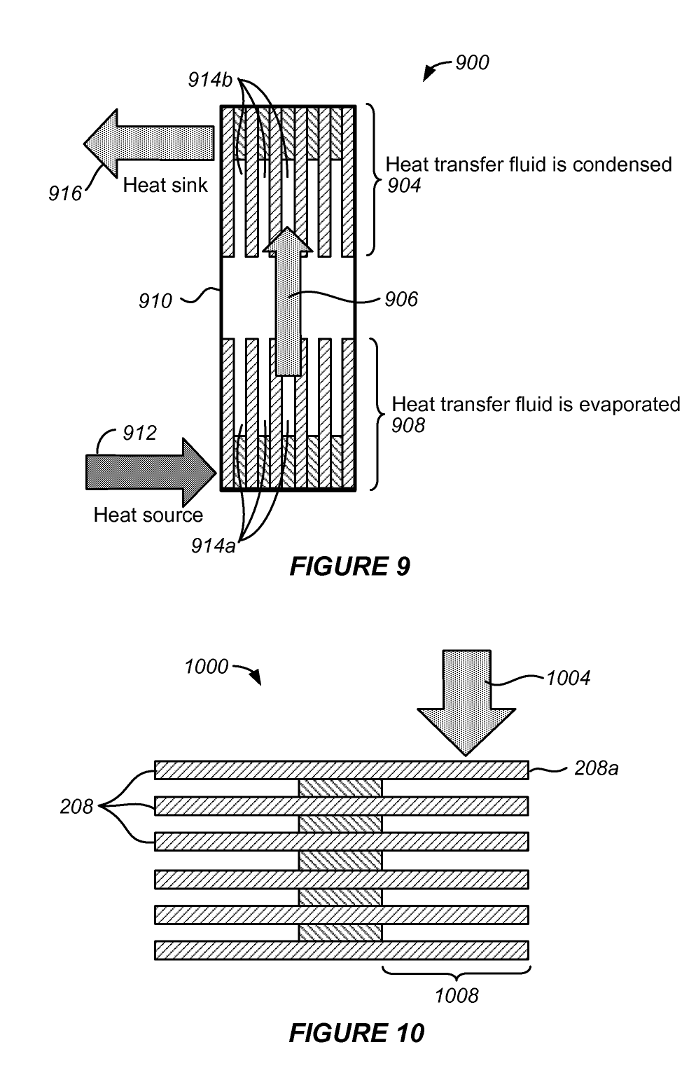

FIG. 9 shows an example of a side view of a heat pipe formed from stacked layered structures. In FIG. 9, a heat pipe 900 is constructed using halves of two stacked layered structures 904 and 908 enclosed by a casing 910. The structures 904 and 908 can be fabricated as described above with reference to FIGS. 1, 2A, and 2B. In FIG. 9, the layers of the respective structures 904 and 908 are substantially aligned with one another and spaced apart from one another in a generally vertical direction as shown in FIG. 9. The structure 908 can be configured to respond to thermal energy from a heat source 912 by causing evaporation of a fluid collected in the gaps 914a of the stacked layered structure 908. The evaporated fluid 906 rises towards stacked layered structure 904. As the evaporated fluid 906 rises into the gaps 914b of the stacked layered structure 904, the fluid 906 is received and condensed in those gaps 914b, allowing thermal energy to be transferred from the condensed fluid out of heat pipe 900 as a heat sink 916, as shown in FIG. 9. The condensed fluid drops back into the gaps 914a of the structure 908, is heated by heat source 912, and the cycle repeats.

In FIG. 9, the heat pipe 900 can be miniaturized, and the structures 904 and 908 can be fabricated with plating techniques as described above. The high surface area of the gaps 914a and 914b formed in alternate first metal layers of the structures 904 and 908 facilitates drawing the fluid into the gaps of the respective structures. In particular, in some implementations, when the fluid wets the surfaces of the structures 904 and 908, the high surface areas of the gaps 914a and 914b facilitate drawing the fluid into the gaps. In some other implementations, a surface treatment can be applied to the surfaces of the structures 904 and 908. The alternate alloy layers of structures 904 and 908 serve as fins for heat transfer. The aspect ratio of the structures 904 and 908 is a parameter, which can affect the fluid behavior based on its surface tension, wetting and thermal characteristics, and boiling point. In some implementations, a relatively large aspect ratio is desirable to obtain a thin film of fluid over the high surface area of a given structure. By contrast, if the aspect ratio is too small, the gaps 914a and 914b may become plugged with fluid, and the heat transfer may be less efficient. Those of ordinary skill in the art should appreciate that modeling and experimentation for a particular implementation can be used to determine the optimal aspect ratio and, thus, the geometry of the structures 904 and 908.

FIG. 10 shows an example of a side view of a stacked layered structure. In FIG. 10, the structure 1000 can be formed as described above with reference to FIGS. 1, 2A, and 2B, and can be used for various structural and protective applications. For example, when an external force 1004 is exerted on a region 1008 of the alternate alloy layers 208, the layers 208 cooperate with one another to provide a non-linear increase in resistance, or bending stiffness, to such forces. That is, the structure 1000 can be deformed responsive to force 1004. Each layer has a certain spring constant k. Thus, a relatively small force 1004 on the top of the structure 1000 causes the top layer 208a to deform. Layer 208a will resist force 1004 linearly based upon a spring constant for layer 208a. As deformation of the top layer 208a increases, more underlying alloy layers 208 are contacted and increase the effective stiffness for further deformation. The force 1004 needed to deform the two layers further increases. As increasing numbers of underlying alloy layers are contacted, the force needed to make additional deformations further increases. Thus, there is a non-linear effect, in that the force needed to do achieve additional deformation increases significantly as with deformation in increasing numbers of alloy layers. The resistance to the force 1004 therefore increases non-linearly with each additional alloy layer 208 that is deformed.

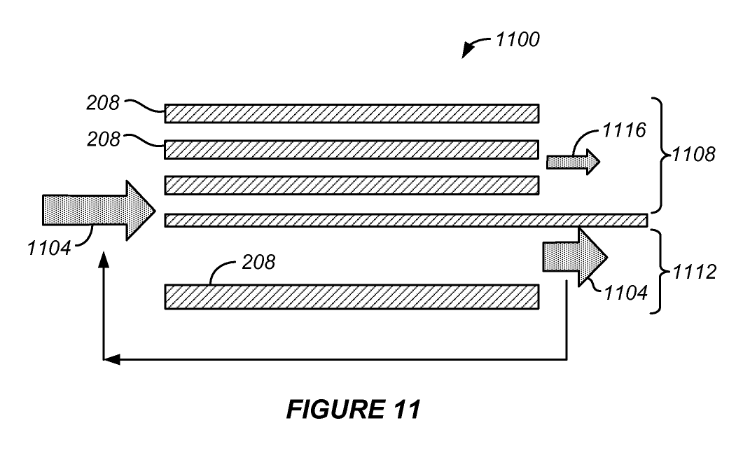

FIG. 11 shows an example of a side view of a micro-fluidic filter formed from a stacked layered structure. In FIG. 11, the first metal layers 204 of FIGS. 2A and 2B (not shown in FIG. 11) can have variations in thickness to define channels of different heights between the alternate alloy layers 208. The formation of alternate metal layers 204 with different thicknesses can be achieved by adjusting the current modulation during the plating method described above to create thicker or thinner alternate metal layers 204. When the metal layers 204 are selectively etched, as described above, the gaps 216a or 216b define channels with desired heights to create coarser or finer filters. That is, the heights of the channels defined by gaps 216a or 216b can be set to define a filter for particles of different sizes. For instance, such filters can be used to separate large chain molecules with different residence times.

In FIG. 11, the structure 1100 can be integrated into a micro-fluidic filter panel. A solution 1104 with particles or with two or more fluids having different densities is introduced on one side. Finer channels are defined in an upper region 1108, and coarser channels are defined in a lower region 1112. The coarser channels allow the solution 1104 to pass through, while the finer channels block the particles or denser fluids to produce a filtered solution 1116. The structure 1100 thus operates as a separation mechanism, and the heights of the channels can be set as desired for the particular application of particles or fluids to be filtered.

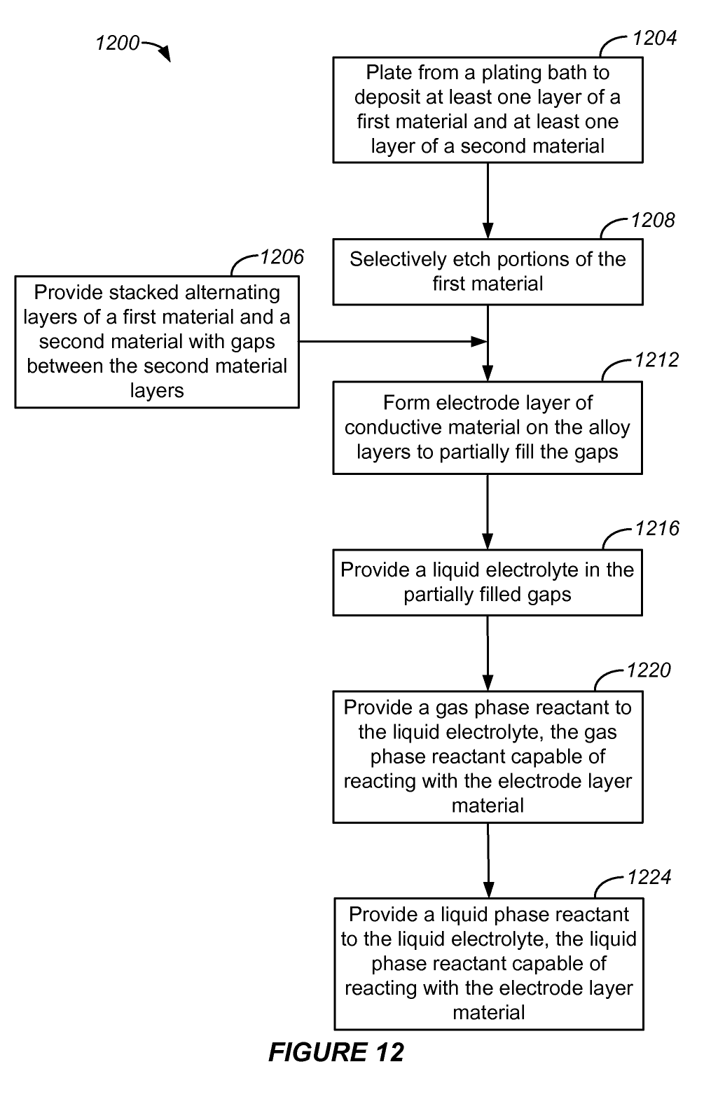

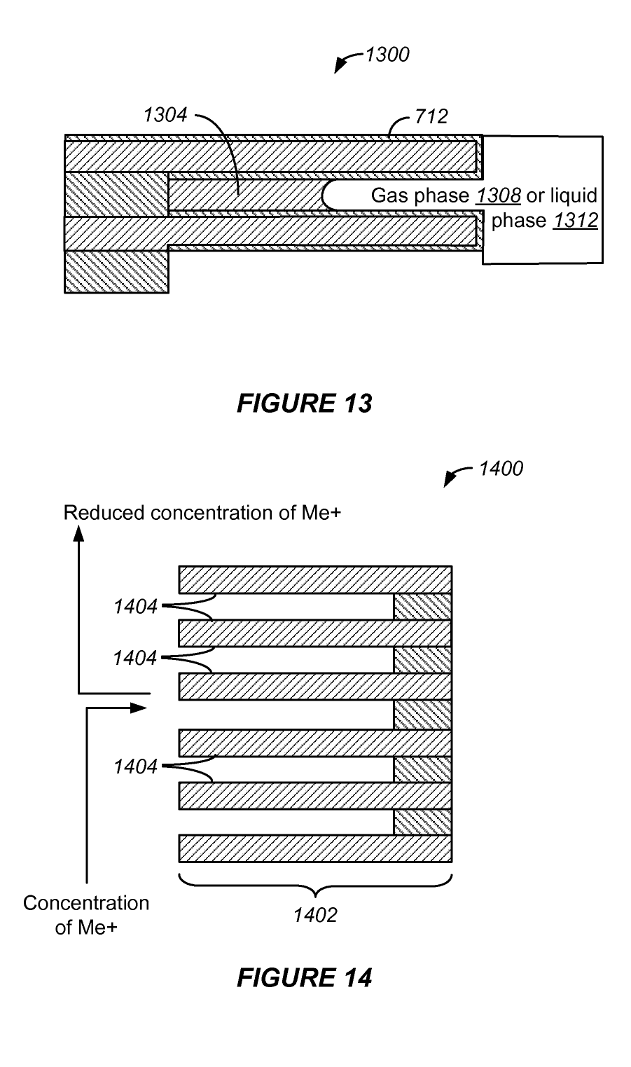

FIG. 12 shows an example of a flow diagram illustrating a method for forming an electrochemical cell from a stacked layered structure serving as a large area electrode or a large area current collector. FIG. 13 shows an example of a side view of an electromechanical cell formed from a stacked layered structure serving as a large area electrode or a large area current collector.

In FIG. 12, method 1200 begins in blocks 1204 and 1208, which are the same as blocks 104 and 108 of FIG. 1. Alternatively, as shown in block 1206, the stacked layered structure 250 including stacked, alternating layers of a first material and a second material, with gaps between the second material layers may be provided for subsequent processing in blocks 1212 through 1224. In some implementations, the first material includes a first metal and the second material includes an alloy including the first metal and a second metal. In such implementations, the stacked layered structure 250 can be manufactured prior to performing the method 1200. In block 1212, an electrode layer 712 of conductive material is formed on the alloy layers, as shown in FIG. 13 and as described above with reference to FIG. 7. This electrode layer 712 can be made of various metals such as Pt. In block 1216, following block 1212, a liquid electrolyte 1304 is introduced to coat the electrode layer 712 surface and at least partially fill gaps between alloy layers. In block 1220, fuel in the form of a gas phase reactant 1308 is introduced to the liquid electrolyte 1304, as shown in FIG. 13. This gas phase reactant 1308 is capable of reacting at the electrode layer 712. In particular, the gas phase reactant 1308 diffuses into the liquid electrolyte 1304 and an electrochemical reaction occurs at the interface of the liquid electrolyte 1304 and the electrode layer 712.

In FIG. 12, in block 1224, following the introduction of the gas phase reactant 1308 in block 1220, a liquid phase reactant 1312 is introduced in the same region as the gas reactant 1308 was introduced in block 1220, as shown in FIG. 13. The liquid phase reactant 1312 of block 1224 is introduced into the liquid electrolyte 1304 and diffuses into the liquid electrolyte. The liquid phase reactant 1312 is capable of reacting with the electrode layer 712. When increasing numbers of layers 204 and 208 are used to form the structure 1300, larger numbers of reaction zones for the gas phase reactant 1308 and the liquid phase reactant 1312 are provided. The structure of FIG. 13 is also applicable for electro-organic synthesis involving two or more phases of liquid electrolyte.

FIG. 14 shows an example of a side view of a large area electrode formed from a stacked layered structure for pollution abatement by plating of metallic ions from dilute solution streams. In FIG. 14, at least one side region 1402 of a stacked layered structure 1400 formed as described above with reference to FIGS. 1, 2A, and 2B can be used for plating metallic ions from dilute streams of fluid containing heavy metals. Large exposed alloy surfaces 1404 of the structure 1400 can be used to plate metallic ions Me+ from a fluid stream. Electricity is applied to the stacked layered structure, in particular, the exposed alloy surfaces 1404, to plate the metallic ions onto alloy surfaces 1404. For instance, Cu, Ni, lead (Pb), chromium (Cr), cadmium (Cd), cobalt (Co), Fe, and zinc (Zn) ions can be plated onto alloy surfaces 1404 of the structure 1400. After some period of time, the amount metallic ions plated on the surface becomes so great that the gaps between the second material layers, as described above with reference to FIG. 3, may become plugged. At such times, the plated metal structures 1400 can be disposed of and replaced. Using such techniques, the pollution problem can be reduced to disposal of the plated large surface area electrode instead of many gallons of dilute solution in which the heavy metal would otherwise be present. Disposal problems can thus be reduced from large volumes of a liquid waste stream using the structure 1400.

FIG. 15 shows an example of a flow diagram illustrating a method of forming an inductor by depositing coil portions around a stacked layered structure. FIG. 15 is described with reference to FIGS. 16A-16E, which show an example of a top view of an inductor at respective stages of fabrication, and with reference to FIGS. 17A-17E, which show an example of a cross-sectional view along lines 17-17 of FIG. 16A of the inductor of FIGS. 16A-16E at the respective stages of fabrication.

In FIG. 15, the method 1500 begins in block 1504 with depositing and patterning a bottom portion 1604 of metal coils on an insulating substrate 1608 such as glass, as shown in FIGS. 16A and 17A. In this example, bottom portion 1604 includes coil segments 1604a-1604e physically and electrically disconnected from one another and diagonally oriented with respect to X and Y axes, for purposes of illustration, on a surface of the substrate 1608 as shown in FIG. 16A. Following block 1504, method 1500 transitions to block 1508, in which a first dielectric passivation layer 1612 is deposited over the bottom portion 1604 of coils and exposed regions 1610 of the surface of the substrate 1608, as shown in FIGS. 16B and 17B.

In FIG. 15, in block 1512, a stacked layered structure (such as stacked layered structure 600 as described above with reference to FIGS. 5, 6A, and 6B) serving as a laminated magnetic core 1616 is deposited on the first dielectric layer 1612, as shown in FIGS. 16C and 17C. The laminated magnetic core 1616 has a longitudinal axis 1620 oriented along the Y axis, such that the magnetic core 1616 overlays portions of the coil segments 1604a-1604e, as shown in FIG. 16C. Following block 1512, method 1500 transitions to block 1516, in which a second dielectric layer 1622 is deposited over the magnetic core 1616 and exposed surface regions of the first dielectric layer 1612, as shown in FIGS. 16D and 17D. In block 1520, vias 1624 are formed, for instance, by etching, to access the bottom portion 1604 of coils.

In FIG. 15, in block 1524, a top portion 1628 of coils is deposited and patterned, including segments 1628a-1628d, as shown in FIGS. 16E and 17E. In this example, segments 1628a-1628d are substantially oriented along the X axis, as shown in FIG. 16E, and have connecting members 1632 substantially oriented along a Z axis, as shown in FIG. 17E, extending through the vias 1624 to connect the top segments 1628a-1628d with respective pairs of bottom segments, as shown in FIGS. 16E and 17E. For example, top segment 1628a electrically couples bottom segments 1604a and 1604b (of FIG. 16A) to each another, top segment 1628b couples bottom segments 1604b and 1604c to each other, and so forth, by virtue of connecting members 1632.

The described implementations may be implemented in any device that is configured to display an image, whether in motion (such as a video) or stationary (such as a still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e-readers), computer monitors, auto displays (such as a speedometer or odometer display, etc.), cockpit controls and/or displays, camera view displays (such as display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., electromechanical systems (EMS), MEMS and non-MEMS), aesthetic structures (such as display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the figures, but instead have wide applicability as will be readily apparent to one having ordinary skill in the art.

An example of a suitable electromechanical systems (EMS) or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

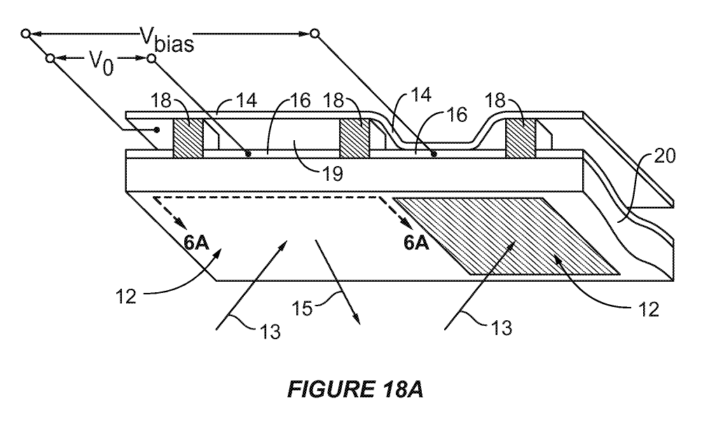

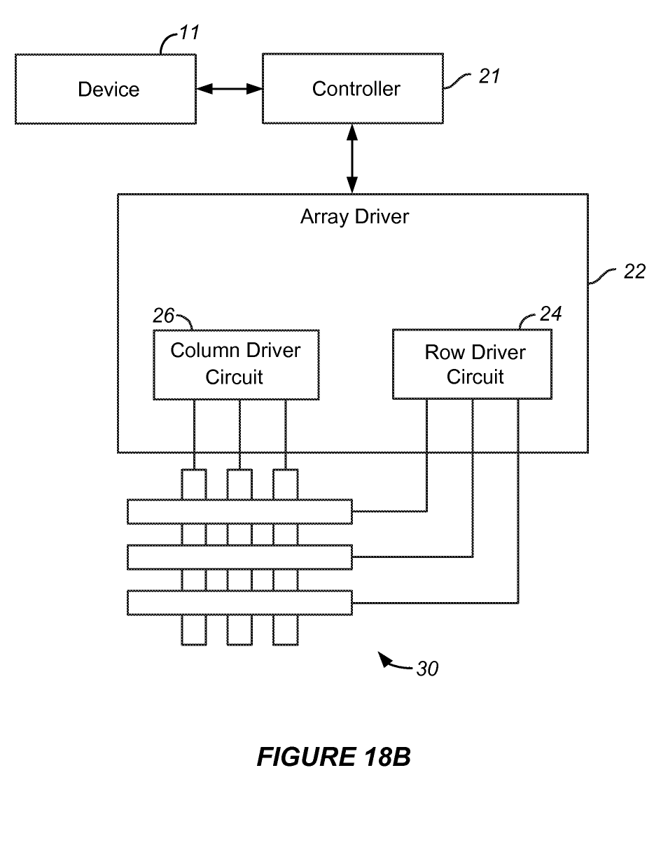

FIG. 18A shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, which may be viewable by a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (such as infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 18A includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V0 applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage Vbias applied across the IMOD 12 on the right is sufficient to maintain the movable reflective layer 14 in the actuated position.

In FIG. 18A, the reflective properties of pixels 12 are generally illustrated with arrows 13 indicating light incident upon the pixels 12, and light 15 reflecting from the IMOD 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the IMOD 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the IMOD 12 on the left in FIG. 18A, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated IMOD 12 on the right in FIG. 18A. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 18B shows an example of a system block diagram illustrating an electronic device incorporating a 3×3 interferometric modulator (IMOD) display. The electronic device of FIG. 18B represents some implementations in which a device 11 incorporating a stacked layered structure constructed in accordance with the implementations described above with respect to FIGS. 1-17 can be incorporated. For example, device 11 can be a capacitor or an inductor formed as described above. The electronic device in which device 11 is incorporated may, for example, form part or all of any of the variety of electrical devices and electromechanical systems devices set forth above, including both display and non-display applications.

Here, the electronic device includes a controller 21, which may include one or more general purpose single- or multi-chip microprocessors such as an ARM®, Pentium®, 8051, MIPS®, Power PC®, or ALPHA®, or special purpose microprocessors such as a digital signal processor, microcontroller, or a programmable gate array. Controller 21 may be configured to execute one or more software modules. In addition to executing an operating system, the controller 21 may be configured to execute one or more software applications, including a web browser, a telephone application, an email program, or any other software application.

The controller 21 is configured to communicate with device 11. The controller 21 also can be configured to communicate with an array driver 22. The array driver 22 can include a row driver circuit 24 and a column driver circuit 26 that provide signals to an array such as a display array or panel 30. One or more components formed of stacked layered structures, for example, in the form of an inductor and/or capacitor as described above can be incorporated into the circuitry of array driver 22. Although FIG. 18B illustrates a 3×3 array of IMODs for the sake of clarity, the display array 30 may contain a very large number of IMODs, and may have a different number of IMODs in rows than in columns, and vice versa. Controller 21 and array driver 22 may sometimes be referred to herein as being “logic devices” and/or part of a “logic system.”

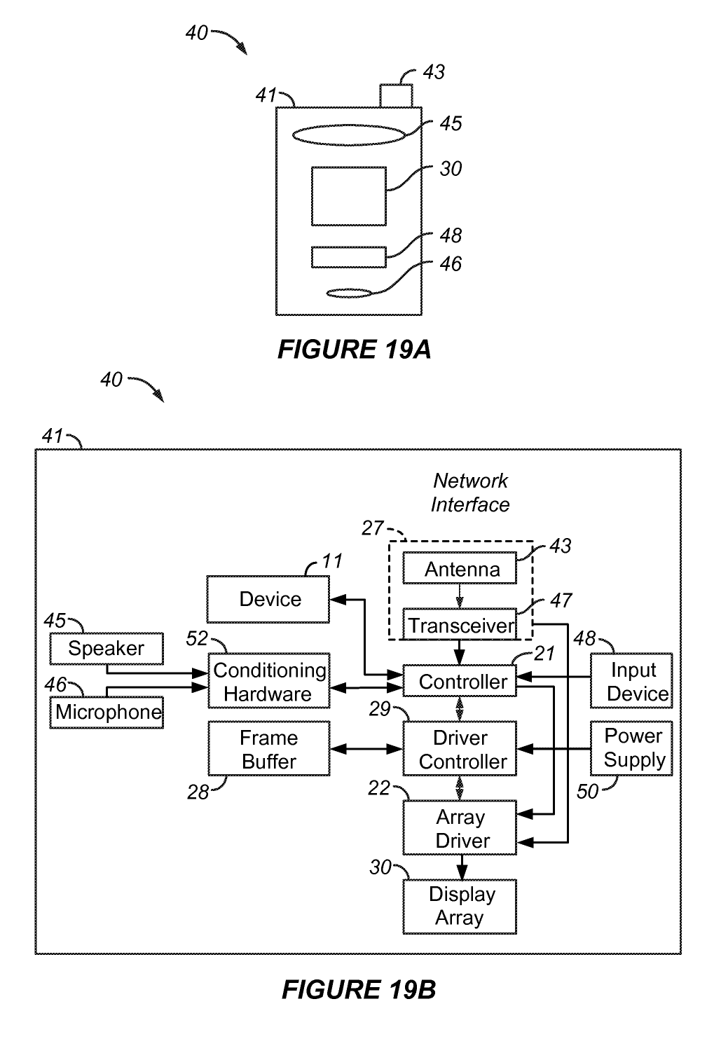

FIGS. 19A and 19B show examples of system block diagrams illustrating a display device 40 that includes a plurality of interferometric modulators. Display device 40 represents one example of an electronic device as described above. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 19B. The display device 40 includes a housing 41 and can include additional components at least partially enclosed therein. For example, the display device 40 includes a network interface 27 that includes an antenna 43, which is coupled to a transceiver 47. The transceiver 47 is connected to a processor 21, which is connected to conditioning hardware 52. The conditioning hardware 52 may be configured to condition a signal, for example, by filtering. The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43. One or more components formed of stacked layered structures, for example, in the form of an inductor and/or capacitor as described above can be incorporated in transceiver 47. For example, transceiver 47 can include circuitry in the form of one or more bandpass filters and/or notch filters, with inductors and capacitors formed of stacked layered structures, to facilitate RF communication.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level. Controller 21 is also configured to interact with device 11 to perform desired operations.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components. In some implementations, a capacitor or an inductor formed of a stacked layered structure as described above is incorporated as a component of conditioning hardware 52.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In some implementations, the power supply 50 incorporates an electrochemical cell or an electromechanical cell formed of a stacked layered structure, as described above with reference to FIGS. 12 and 13. The power supply 50 also can be a renewable energy source, a capacitor, for instance, incorporating a stacked layered structure as described above, or a solar cell, including a plastic solar cell or solar-cell paint. The power supply 50 also can be configured to receive power from a wall outlet. In some implementations, the power supply 50 includes power conditioning circuitry with one or more capacitors and/or inductors formed of a stacked layered structure as described in the implementations above.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of forming a plurality of stacked layers on a substrate from a plating bath comprising:
plating to deposit at least one layer of a first material and at least one layer of a second material; and
selectively etching portions of the first material.

2. The method of claim 1, wherein:
the first material is a first metal, and the second material is an alloy including the first metal and a second metal;
plating includes modulating a plating current to deposit a plurality of alternate layers of the first metal and the alloy; and
selectively etching includes forming gaps between regions of the alloy layers, the alternate layers of etched first metal layers and alloy layers defining a stacked layered structure.

3. The method of claim 1, wherein the substrate is formed of an insulating material including one or more items selected from the group consisting of: glass, ceramic, plastic, high-resistivity silicon, silicon on insulator (SOI), gallium arsenide (GaAs), and indium phosphide (InP).

4. The method of claim 1, wherein the substrate is a rigid substrate.

5. The method of claim 2, wherein the first metal includes Copper (Cu).

6. The method of claim 2, wherein the second metal includes one or more items selected from the group consisting of: Nickel (Ni), Cobalt (Co), Iron (Fe), and combinations thereof.

7. The method of claim 2, further comprising:
depositing a dielectric material on a surface of the stacked layered structure; and
depositing a conductive layer on the dielectric material to define a capacitor including a first electrode and a second electrode, the first electrode being the stacked layered structure, and the second electrode being the conductive layer.

8. The method of claim 7, wherein the dielectric material includes one or more items selected from the group consisting of: Aluminum Oxide (Al₂O₃), Zirconium oxide (ZrO₂), and Tantalum dioxide (Ta₂O₅).

9. The method of claim 7, wherein the dielectric material is deposited using atomic layer deposition (ALD).

10. The method of claim 7, wherein the conductive layer includes one or more items selected from the group consisting of: Ruthenium (Ru), Platinum (Pt), Rhodium (Rh), and Iridium (Ir).

11. The method of claim 7, wherein the conductive layer is deposited using electroless plating.

12. The method of claim 2, further comprising:
forming a sensor layer on the stacked layered structure.

13. The method of claim 2, wherein the plating current modulation is adjusted such that a first one of the first metal layers has a first thickness, and a second one of the first metal layers has a second thickness different from the first thickness.

14. The method of claim 2, further comprising:
forming an electrode layer of conductive material on the alloy layers to partially fill the gaps.

15. The method of claim 14, further comprising:
providing a liquid electrolyte in the partially filled gaps.

16. The method of claim 15, further comprising:
providing a gas phase reactant to the liquid electrolyte, the gas phase reactant capable of reacting with the electrode layer material.

17. The method of claim 15, further comprising:
providing a liquid phase reactant to the liquid electrolyte, the liquid phase reactant capable of reacting with the electrode layer material.

18. The method of claim 2, further comprising:
depositing a dielectric material in the gaps between the alloy layers.

19. A device comprising:
at least one layer of a first material; and
at least one layer of a second material having one or more portions extending beyond the at least one first material layer.

20. The device of claim 19, wherein:
the first material is a first metal, and the second material is an alloy including the first metal and a second metal;
the layers include a plurality of alternate layers of the first metal and the alloy; and
the one or more extending portions of the alloy layers define one or more gaps between regions of the alloy layers, the alternate layers of first metal layers and alloy layers defining a stacked layered structure.

21. The device of claim 20, further comprising:
a dielectric material disposed on a surface of the stacked layered structure; and
a conductive layer disposed on the dielectric material to define a capacitor including a first electrode including the stacked layered structure and a second electrode including the conductive layer.

22. The device of claim 21, wherein the dielectric material and the conductive layer partially fill the one or more gaps.

23. The device of claim 20, wherein the stacked layered structure is at least a part of a device selected from the group consisting of: a capacitor, an inductor, a sensor, a catalyst matrix, a heat pipe, a fluidic filter, an electrochemical cell, an electromechanical cell, and an electrode.

24. The device of claim 20, wherein the stacked layered structure is included in an apparatus, the apparatus further comprising:
a display;
a processor configured to communicate with the display, the processor being configured to process image data; and
a memory device configured to communicate with the processor.

25. The device of claim 24, the apparatus further comprising:
a driver circuit configured to send at least one signal to the display, the driver circuit including the stacked layered structure.

26. The device of claim 24, the apparatus further comprising:
a power supply configured to provide power to the processor, the power supply including the stacked layered structure.

27. The device of claim 25, the apparatus further comprising:
a controller configured to send at least a portion of the image data to the driver circuit.

28. The device of claim 24, the apparatus further comprising:
an image source module configured to send the image data to the processor.

29. The device of claim 28, wherein the stacked layered structure is included in at least one of a receiver, transceiver, and transmitter of the image source module.

30. The device of claim 24, the apparatus further comprising:
an input device configured to receive input data and to communicate the input data to the processor.

31. An inductor comprising:
a stacked layered structure including:
at least one layer of a first metal, and
at least one layer of an alloy including the first metal and a second metal, the at least one alloy layer having one or more portions extending beyond the at least one first metal layer, the one or more extending portions of the alloy layers defining one or more gaps between regions of the alloy layers; and
one or more coils disposed about the stacked layered structure.

32. The inductor of claim 31, further comprising:
a dielectric material disposed on a surface of the stacked layered structure, the one or more coils disposed about the dielectric material.

33. The device of claim 32, wherein the dielectric material at least partially fills the one or more gaps.

34. A heat pipe comprising:
a heat source structure including a first plurality of stacked layers; and
a heat sink structure including a second plurality of stacked layers, the first and second plurality of stacked layers each including:
at least one layer of a first material, and
at least one layer of a second material having one or more portions extending beyond the at least one first material layer;
the heat source structure capable of causing evaporation of a fluid responsive to receiving thermal energy from a heat source, the heat sink structure situated proximate to the heat source structure so as to receive the evaporated fluid, the heat sink structure capable of transferring heat responsive to the received evaporated fluid so as to condense the evaporated fluid.

35. The heat pipe of claim 34, wherein a layer of the heat source structure and a layer of the heat sink structure are oriented in the same plane.

36. The heat pipe of claim 34, wherein in each plurality of stacked layers:
the first material is a first metal, and the second material is an alloy including the first metal and a second metal;
the stacked layers include a plurality of alternate layers of the first metal and the alloy; and
the one or more extending portions of the alloy layers define one or more gaps between regions of the alloy layers.

37. Apparatus comprising:
a plurality of separated, stacked alloy layers formed of an alloy of a first metal and a second metal, the separated metal layers defining gaps therebetween; and
separating means for separating the stacked metal layers from each other to form gaps between regions of the alloy layers, the alternate layers of the separating means and the alloy layers defining a stacked layered structure.

38. The apparatus of claim 37, further comprising:
a dielectric material disposed on a surface of the stacked layered structure; and
conductive means for storing charge, the conductive means disposed on the dielectric material, the stacked layered structure defining a first electrode of a capacitor, and the conductive means defining a second electrode of the capacitor.

39. The apparatus of claim 37, further comprising:
one or more coils disposed about the stacked layered structure.
